(19) United States
(12) Patent Application Publication
(10) Pub. No.: US 2016/0091408 A1
(43) Pub. Date: Mar. 31, 2016

(54) DETECTION SYSTEM FOR IMPROVING ACCURACY OF HEMATOCRIT MEASUREMENT AND OPERATION CONTROL METHOD

(71) Applicant: EDAN INSTRUMENTS INC., Shenzhlenl Guangdong (CN)

(72) Inventors: Xiaofei XIANG, Shenzhen, Guangdong (CN); Yinhui LU, Shenzhen, Guangdong (CN); Zhixiang ZHAO, Shenzhen, Guangdong (CN)

(21) Appl. No.: 14/777,771

(22) PCT Filed: Apr. 3, 2013
(86) PCT No.: PCT/CN2013/073740

§ 371 Date: Sep. 17, 2015

(30) Foreign Application Priority Data
Mar. 18, 2013 (CN) 201310085845.0

(51) Int. Cl. G01N 15/05; G01N 15/06

(52) U.S. Cl. CPC G01N 15/05; G01N 15/0656; G01N 2015/055

(57) ABSTRACT

The present invention relates to a detection system for improving accuracy of hematocrit measurement and an operation control method. The detection system for hematocrit measurement comprises a central processing unit, an excitation source unit, a blood sample unit, a precise measurement circuit unit and a signal collecting unit. The present invention has the beneficial effects that the HCT measurement precision is improved by generating a sine wave by the excitation source unit and performing control by the central processing unit; the detection system of the present invention is simple and reliable, and implements precise measurement; and the measurement precision in the present invention is far greater than that of a conventional measurement technology and can be within 0.2%. Furthermore, due to a self-detection function, the measurement is quite reliable without the risk of resulting incorrect measurement data from a circuit failure.

### FIELD OF THE INVENTION

The present invention relates to the field of medical instruments, in particular to a detection system for improving accuracy of hematocrit measurement and an operation control method.

### BACKGROUND OF THE INVENTION

HCT, i.e., hematocrit, is an important parameter in the field of blood analysis. Blood, after anti-coagulation treatment, may be centrifugally separated into two parts: plasma and blood cells. Assumed that blood is centrifuged in a particular test tube (Wintrobe tube) at a specified speed for a specified period of time, eventually making the red blood cells completely packed on the bottom of the test tube. In this case, red blood cells get close to each other to exclude plasma as much as possible, and the plasma is now entirely squeezed onto the blood cells. At this moment, the percentage of red blood cells in the whole blood is the hematocrit, i.e., the volume (or percentage) of the packed red blood cells, also called packed cell volume. Hematocrit is usually abbreviated as HCT. At present, the volume of red blood cells per liter of blood (L/L) is often regarded as the unit of measurement.

HCT is helpful in knowing the increase or reduction of red blood cells. When the absolute value of red blood cells increases due to various reasons, HCT increases accordingly. The reduction of HCT is related to various anemia diseases.

[English abbreviations] HCT, Ht, packed cell volume (PCV)

[Reference values] Male: 0.40-0.50 L/L (40%-50%); female: 0.37-0.45 L/L (37%-45%)

In the field of blood analysis, HCT measurement is usually done by AC coupling. An excitation signal is output by an excitation source, and an AC signal value corresponding to a blood impedance is collected by the voltage division of serially-connected standard resistors and blood sample impedance. Due to the serial connection, the signal of the blood is proportional to the impedance. Therefore, the blood impedance is obtained by measuring this signal. In a traditional HCT detection method, the excitation source is a PWM wave. Such a traditional method has many shortcomings although it is simple.

First, the precision of HCT measurement is greatly decreased, because the amplitude of the PWM wave generated by central processing is quite unstable and is likely to drift. The short-term stability of the waveform amplitude is merely about 5%. The change in amplitude will be greater if long-term drift is taken into account.

Second, it is difficult to generate a sine wave of high frequency by central processing. The PWM wave has, when applied to the blood after filtering treatment, an irregular waveform rich in spectrum. Harmonic distortion will be inevitably caused after amplification and conversion, which further increases the HCT detection error. Therefore, such a traditional GCT detection method is merely suitable for occasions without high requirements. If a sine wave is generated by central processing and internal DAC, significant occupation of the central processing resources will be caused due to a too high refresh rate (In order to generate a sine wave 100 KHz, according to the DAC method, a smooth sine wave may be formed by drawing at least 50 points within each cycle. That is, the refresh rate of DAC reaches at least SMsps, one refresh every 0.2 μs). Consequently, other programs are unable to work. Thus, it is desirable.

In addition, the traditional HCT detection devices have complex design and poor reliability.

Therefore, in conclusion, it is difficult to achieve precise measurement by the traditional HCT measurement devices.

### SUMMARY OF THE INVENTION

In order to solve the problems of the prior art, the present invention provides a detection system for improving accuracy of hematocrit measurement.

The present invention provides a detection system for improving accuracy of hematocrit measurement, including a central processing unit, an excitation source unit, a blood sample unit, a precise measurement circuit unit and a signal collecting unit; the central processing unit is connected to the excitation source unit and configured to output a control command to the excitation source unit; the excitation source unit is configured to generate a sine wave, and the output end of the excitation source unit is connected to the input end of the blood sample unit; the output end of the blood sample unit is communicated to the input end of the precise measurement circuit unit, and the blood sample unit is configured to collect a blood sample impedance signal; the precise measurement circuit unit is configured to complete amplification of the signal and conversion of the signal to an effective value after the amplification; the signal collecting unit is configured to complete single-ended to differential amplification and analog-digital conversion of a signal of the effective value of the blood impedance; the output end of the precise measurement circuit unit is connected to the signal collecting unit, the central processing unit is connected to the signal collecting unit, and the signal collecting unit outputs the processed data of the effective value of the blood impedance to the central processing unit; and the central processing unit calculates a blood impedance according to the effective value of the blood impedance, and the central processing unit outputs a control command to the signal collecting unit.

As a further improvement of the present invention, the excitation source unit includes a waveform generator circuit and a waveform converter circuit connected to the waveform generator circuit; the waveform generator circuit is configured to generate a sine wave; and the waveform converter circuit is configured to isolate the DC component of a signal output from the waveform generator circuit and convert a positive sine signal into a positive and negative half-cycle sine wave.

As a further improvement of the present invention, the waveform generator circuit includes a monolithic function generator, a crystal oscillator unit and a precise voltage reference unit, the precise voltage reference unit being connected to a voltage reference interface of the monolithic function generator and configured to provide a precise voltage reference for the monolithic function generator, the monolithic function generator being connected to the crystal oscillator unit, the crystal oscillator unit being configured to provide a high-precision clock signal; and the input end of the waveform converter circuit is connected to the output end of the monolithic function generator, and configured to isolate the DC component of a signal output from the monolithic function generator and convert a positive sine signal into a positive and negative half-cycle sine wave.

As a further improvement of the present invention, the waveform converter circuit includes a capacitor, a first resistor and a first operational amplifier unit; one end of the capacitor is connected to the output end of the monolithic function generator, and the other end of the capacitor is connected to the resistor and the in-phase input end of the first operational amplifier unit; the other end of the first resistor is grounded; the in-phase end of the first operational amplifier unit is connected to a common node of the capacitor and the first resistor; and one end of a second resistor is connected to the output end of the first operational amplifier unit.

As a further improvement of the present invention, the blood sample unit is a circuit to be tested; the blood sample unit includes a second resistor, a fifth resistor, an analog switch and a blood equivalent impedance unit; one end of the second resistor is connected to the output end of the excitation source unit; one end of the blood equivalent impedance unit is connected to the second resistor, and the other end of the blood equivalent impedance unit is grounded; one end of the fifth resistor is connected to the second resistor, and the other end of the fifth resistor is connected to one end of the analog switch; the other end of the analog switch is grounded; and both the second resistor and the fifth resistor are standard resistors.

As a further improvement of the present invention, the precise measurement circuit unit includes a second operational amplifier unit, a third resistor, a fourth resistor and a root mean square converter chip; the in-phase end of the second operational amplifier unit is connected to a common node of the second resistor and the blood equivalent impedance unit, and the out-phase end of the second operational amplifier unit is connected to a common node of the third resistor and the fourth resistor; the output of the second operational amplifier unit is connected to the third resistor and the input end of the root mean square converter chip, and the input end of the root mean square converter chip is connected to a common node of the output end of the second operational amplifier unit and the third resistor; and the other end of the fourth resistor is grounded.

As a further improvement of the present invention, the signal collecting unit includes a high-resolution analog-digital converter, an analog-digital converter driving circuit and a precise voltage reference unit; the input end of the analog-digital converter driving circuit is connected to the output end of the root mean square converter chip, and the output end of the analog-digital converter driving circuit is connected to the input end of the high-resolution analog-digital converter; the high-resolution analog-digital converter is connected to the output end of the precise voltage reference unit; and the high-resolution analog-digital converter is connected to the central processing unit.

As a further improvement of the present invention, the monolithic function generator is a direct digital frequency synthesizer which is produced by the AD Company (model: AD9832); and the high-resolution analog-digital converter is a Delta-Sigma analog-digital converter.

As a further improvement of the present invention, there are two precise voltage reference units, respectively a first precise voltage reference unit and a second precise voltage reference unit; the first precise voltage reference unit is connected to the voltage reference interface of the monolithic function generator and configured to provide a precise voltage reference for the monolithic function generator; and the high-resolution analog-digital converter is connected to the output end of the second precise voltage reference unit.

The present invention further provides an operation control method for a detection system, including the following steps:

A. generating a standard sine wave: outputting, by a central processing unit, an instruction to a monolithic function generator to control the monolithic function generator to generate a standard sine wave;

B. setting a standard value: turning an analog switch off, not accessing a blood equivalent impedance unit to the blood, and placing a standard resistor for scaling into the blood equivalent impedance unit;

C. scaling a circuit: setting M scaling points within a typical impedance measurement range from 1K to 15K, where M is greater than or equal to 2, starting the circuit once for scaling each time when one standard resistor is placed to the blood equivalent impedance unit in step B, and repeatedly executing step B and step C for M times; at the end of scaling, saving a code value obtained by ADC (analog-digital conversion) corresponding to each of the standard resistors into an internal memory of the central processing unit to obtain a correspondence between the code value obtained by ADC and the standard resistor;

D. back-testing of the scaling: accessing a resistor having a resistance of R to the original blood equivalent impedance unit Rx, judging whether the measurement deviation exceeds a preset deviation value, if so, returning to step B; and if not, executing step E, where R is from 1KΩ to 10KΩ; and

E: circuit self-detection: turning the analog switch on, accessing the fifth resistor to the measurement circuit to measure the resistance of the fifth resistor, judging whether the error of the fifth resistor exceeds a preset value, if so, giving a prompt indicative of circuit abnormality and automatically terminating the measurement, and if not, performing the detection task by the detection system.

The present invention has the beneficial effects that the HCT measurement precision is improved by generating a sine wave by the excitation source unit and performing control by the central processing unit; the detection system of the present invention is simple and reliable, and implements precise measurement.

### BRIEF DESCRIPTION OF THE DRAWINGS

FIG. 1 is a principle block diagram of a detection system according to the present invention;

FIG. 2 is a principle diagram of an embodiment of the detection system according to the present invention;

FIG. 3 is a flowchart of an operation control method according to the present invention; and

FIG. 4 is a diagram of circuit scaling according to the present invention.

### DETAILED DESCRIPTION OF THE PREFERRED EMBODIMENTS

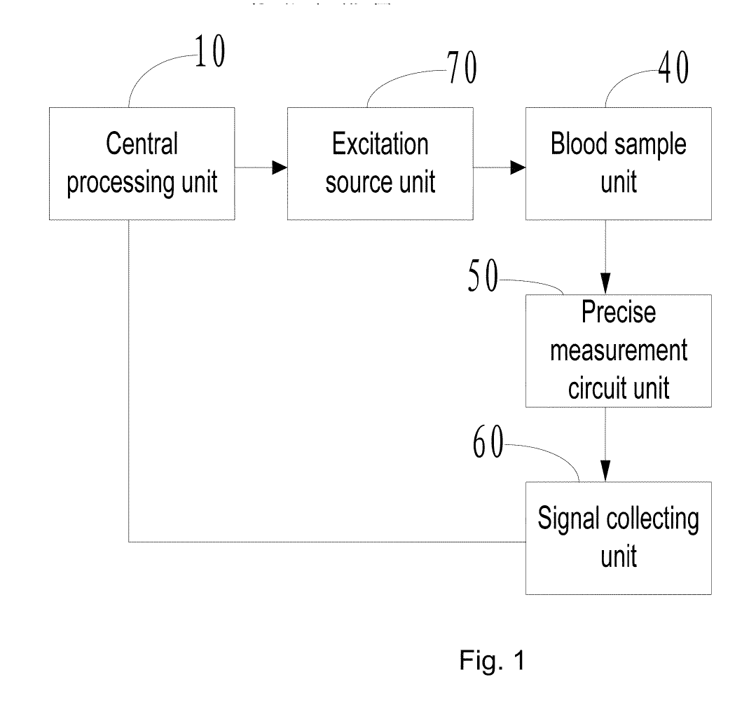

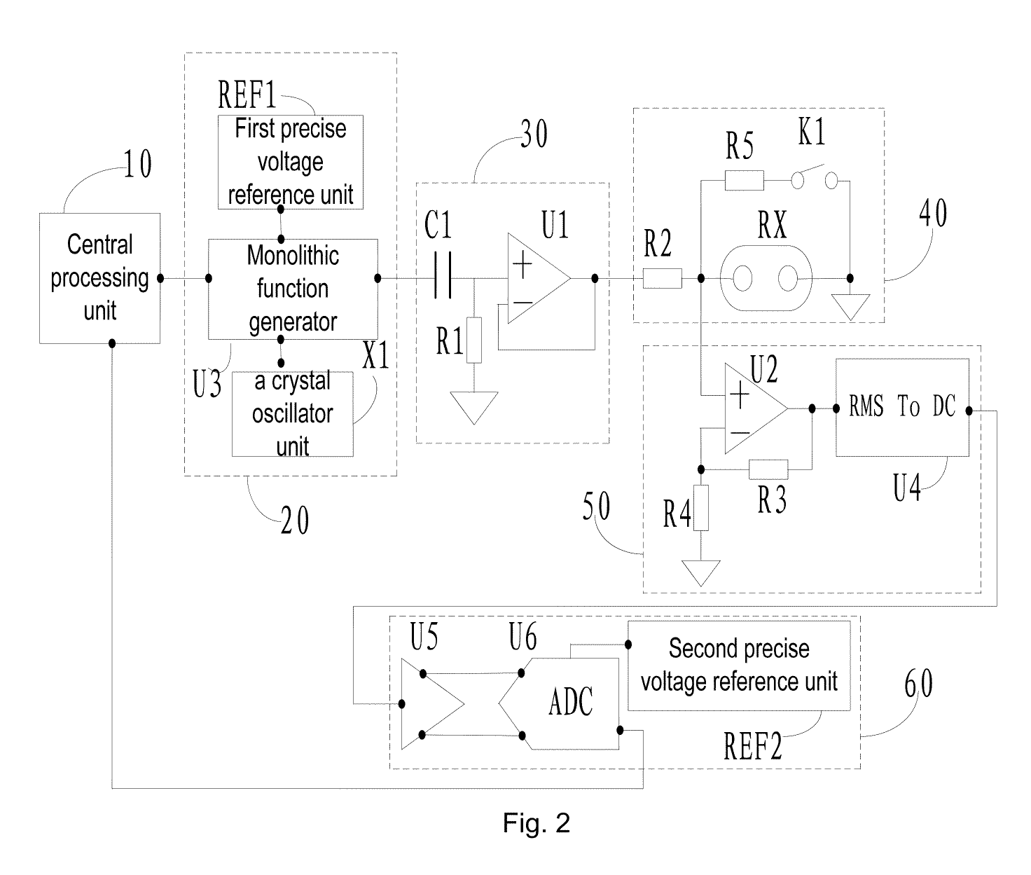

As shown in FIG. 1 and FIG. 2, the present invention provides a detection system for improving accuracy of hematocrit measurement, including a central processing unit 10, an excitation source unit 70, a blood sample unit 40, a precise measurement circuit unit 50 and a signal collecting unit 60; the central processing unit 10 is connected to the excitation source unit 70 and configured to output a control command to the excitation source unit 70; the excitation source unit 70 is configured to generate a sine wave, and the output end of the excitation source unit 70 is connected to the input end of the blood sample unit 40; the output end of the blood sample unit 40 is communicated to the input end of the precise measurement circuit unit 50, and the blood sample unit 40 is configured to collect a blood sample impedance signal; the precise measurement circuit unit 50 is configured to complete amplification of the signal and conversion of the signal to an effective value after the amplification; the signal collecting unit 60 is configured to complete single-ended to differential amplification and analog-digital conversion of a signal of the effective value of the blood impedance; the output end of the precise measurement circuit unit 50 is connected to the signal collecting unit 60, the central processing unit 10 is connected to the signal collecting unit 60, and the signal collecting unit 60 outputs the processed data of the effective value of the blood impedance to the central processing unit 10; and the central processing unit 10 calculates a blood impedance according to the effective value of the blood impedance, and the central processing unit 10 outputs a control command to the signal collecting unit 60.

The central processing unit 10 is connected to the monolithic function generator U3 through an SPI interface. Of course, the central processing unit 10 may be communicated to the monolithic function generator U3 through a 12C or GPIO.

The excitation source unit 70 includes a waveform generator circuit 20 and a waveform converter circuit 30; the waveform generator circuit 20 includes a monolithic function generator U3, a crystal oscillator unit X1 and a precise voltage reference unit; the first precise voltage reference unit REF1 is connected to the voltage reference interface of the monolithic function generator U3 and configured to provide a precise voltage reference for the monolithic function generator U3; the monolithic function generator U3 is connected to the crystal oscillator unit X1 and the crystal oscillator unit X1 is configured to provide a high-precision clock signal; and the input end of the waveform converter circuit 30 is connected to the output end of the monolithic function generator U3, and the waveform converter circuit 30 is configured to isolate the DC component of a signal output from the monolithic function generator U3 and convert a positive sine signal into a positive and negative half-cycle sine wave.

As the monolithic function generator U3 is connected to the crystal oscillator unit X1 and the crystal oscillator unit X1 is configured to provide a high-precision clock signal, the frequency of the output waveform may be made quite stable. The monolithic function generator U3 is a programmable monolithic function generator which has a waveform update rate up to 25 MHz and can generate a quite ideal sine wave. The monolithic function generator U3 is a direct digital frequency synthesizer which is produced by the AD Company model: AD9832, its output waveform amplitude is determined by commands input by the first precise voltage reference unit REF1 and the central processing unit 10 and its output waveform frequency is determined by the crystal oscillator unit X1.

The waveform converter circuit 30 includes a capacitor C1, a first resistor R1 and a first operational amplifier unit U1; one end of the capacitor C1 is connected to the output end of the monolithic function generator U3, and the other end of the capacitor C1 is connected to the resistor R1 and the in-phase input end of the first operational amplifier unit U1; the other end of the first resistor R1 is grounded; and the in-phase end of the first operational amplifier unit U1 is connected to a common node of the capacitor C1 and the first resistor R1.

The blood sample unit 40 is a circuit to be tested; the blood sample unit 40 includes a second resistor R2, a fifth resistor R5, an analog switch K1 and a blood equivalent impedance unit RX; one end of the second resistor R2 is connected to the output end of first operational amplifier unit U1; one end of the second resistor R2 is connected to the output end of the excitation source unit 70; one end of the blood equivalent impedance unit RX is connected to the second resistor R2, and the other end of the blood equivalent impedance unit RX is grounded; one end of the fifth resistor R5 is connected to the second resistor R2, and the other end of the fifth resistor R5 is connected to one end of the analog switch K1; the other end of the analog switch K1 is grounded; and both the second resistor R2 and the fifth resistor R5 are standard resistors.

The second resistor R2 is used for realizing voltage division with the blood impedance, to attenuate the AC signal strength on the blood, in order to avoid unnecessary chemical reactions. The fifth resistor R5 and the analog switch K1 are used for self-detection of the channels to be tested. This circuit is self-detected every time of blood measurement and this ensures the measurement reliability of this device. Due to the serial connection between the blood impedance, the signal amplitude on the blood and the corresponding impedance form a quadratic function. In the present invention, by multi-point scaling and performing piecewise linear treatment, a broken line approaching to an ideal curve is obtained. The precision of calculation is greatly improved while simplifying the calculation.

The precise measurement circuit unit 50 includes a second operational amplifier unit U2, a third resistor R3, a fourth resistor R4 and a root mean square converter chip U4; the in-phase end of the second operational amplifier unit U2 is connected to a common node of the second resistor R2 and the blood equivalent impedance unit RX, and the out-phase end of the second operational amplifier unit U2 is connected to a common node of the third resistor R3 and the fourth resistor R4; the output of the second operational amplifier unit U2 is connected to the third resistor R3 and the input end of the root mean square converter chip U4, and the input end of the root mean square converter chip U4 is connected to a common node of the output end of the second operational amplifier unit U2 and the third resistor R3; and the other end of the fourth resistor R4 is grounded.

In the root mean square converter chip U4, the RMS (root mean square) chip is quite stable, thereby overcoming the temperature drift problem of a conventional diode rectifier circuit, the non-linear problem and the long-term stability problem.

The function of the root mean square converter chip U4 is to complete the root mean square conversion of the input signal and output a DC signal having a size exactly equal to the effective value of the input AC signal. The root mean square converter chip U4 employed in this embodiment has a linearity up to 0.02%, which can ensure a quite high detection precision. This index is extremely important to the measurement of the effective value, and can not be calibrated or eliminated.

The signal collecting unit 60 includes a high-resolution analog-digital converter U6, an analog-digital converter driving circuit U5 and a second precise voltage reference unit REF2; the input end of the analog-digital converter driving circuit U5 is connected to the output end of the root mean square converter chip U4, and the output end of the analog-digital converter driving circuit U5 is connected to the input end of the high-resolution analog-digital converter U6; the high-resolution analog-digital converter U6 is connected to the output end of the second precise voltage reference unit REF2; and the high-resolution analog-digital converter U6 is connected to the central processing unit 10.

The first precise voltage reference unit REF1 and the second precise voltage reference unit REF2 may be combined. This may also achieve the purpose of connecting to the voltage reference interface of the monolithic function generator U3 and to the high-resolution analog-digital converter U6.

The analog-digital converter driving circuit U5 completes single-ended to differential amplification and the signal gain is doubled. With regard to the high-resolution analog-digital converter U6, as the collected signal is a DC signal, the conversion precision is much required than the conversion rate. Therefore, as a preferred implementation, the high-resolution analog-digital converter U6 is a Delta-Sigma analog-digital converter. The precision of signal collection and conversion of the high-resolution analog-digital converter U6 is determined by the ADC valid bits of the high-resolution analog-digital converter U6 and the precision of the second precise voltage reference unit REF2, which may both reach a high precision. In a preferred embodiment, the high-resolution analog-digital converter U6 is 24-bit, and the typical value of the valid bits of the high-resolution analog-digital converter U6 may reach 21.5 dB. The initial voltage precision of the voltage reference is 0.06%. Due to the gain error of the high-resolution analog-digital converter U6, and as both the imbalance and the initial precision of the voltage reference may be eliminated during calibration, the error of the signal collecting unit is mainly resulted from the temperature drift of the high-resolution analog-digital converter U6. The temperature drift reference depends upon the long-term stability. In this embodiment, the temperature drift of the high-resolution analog-digital converter U6 is 2 ppm/, an extremely low value which can be completely ignored, when compared with the temperature drift reference of 9 ppm/. When the temperature changes by 16, change in the temperature drift reference is just 144 ppm, and the long-term drift reference is below 50 ppm. Therefore, the error of the measurement circuit may be controlled at 200 ppm, i.e., within 0.02%.

The central processing unit 10 is connected to the high-resolution analog-digital converter U6 through an SPI interface. Of course, the central processing unit 10 may be communicated to the high-resolution analog-digital converter U6 through a 12C or GPIO.

The excitation source unit 70 may be an active crystal-oscillation frequency-division or high-speed digital-analog converter. The RMS chip may be replaced by a high-resolution analog-digital converter.

In the present invention, a standard sine wave is generated by the first precise voltage reference unit REF1 in cooperation with the monolithic function generator U3 (DDS), direct digital frequency synthesizer, the amplitude is quite stable and completely controlled by the first precise voltage reference unit REF1, and the precision of the amplitude may be within 0.02%, so that the HCT measurement error caused by the amplitude drift of the excitation source may be significantly solved; meanwhile, with the precise root mean square converter chip U4, the conversion may realize a precision within 0.15%, with simple signal chains and fewer links; two key links which may influence the measurement precision, i.e., the error of the excitation source and the error of the measurement circuit, are easily controlled, so that the measurement precision of the present invention is far greater than that of a conventional measurement technology and can be within 0.2%. Furthermore, due to a self-detection function, the measurement is quite reliable without the risk of resulting incorrect measurement data from a circuit failure.

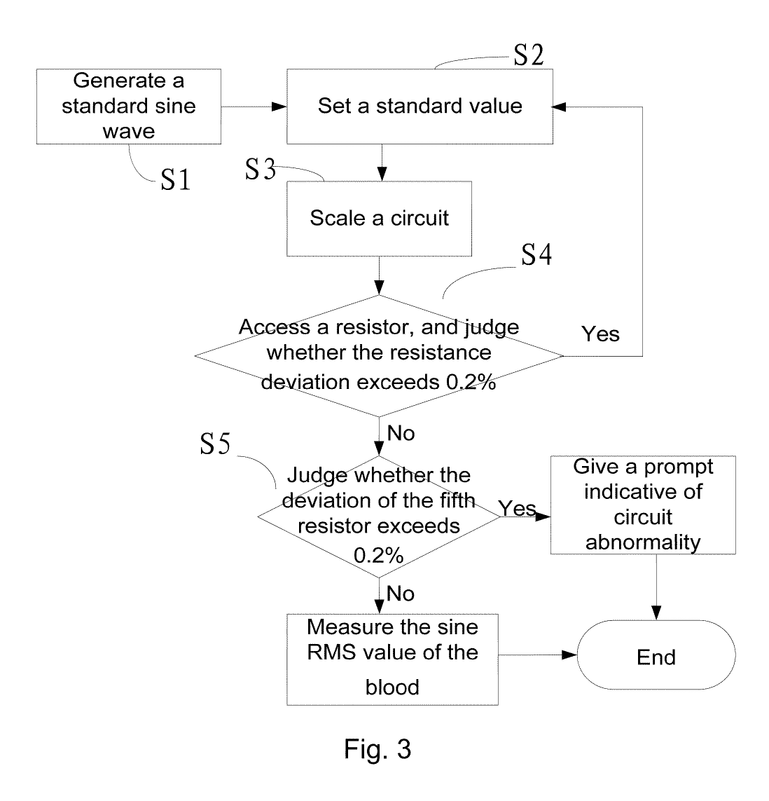

As shown in FIG. 3, the present invention further discloses an operation control method for a detection system, including the following S1 to S5:

S1: generating a standard sine wave: outputting, by a central processing unit, an instruction to a monolithic function generator to control the monolithic function generator to generate a standard sine wave;

S2: setting a standard value: turning an analog switch off, not accessing a blood equivalent impedance unit to the blood, and placing a standard resistor for scaling into the blood equivalent impedance unit;

S3: scaling a circuit: setting M scaling points within a typical impedance measurement range from 1K to 15K, where M is greater than or equal to 2, starting the circuit once for scaling each time when one standard resistor is placed to the blood equivalent impedance unit in step B, and repeatedly executing step B and step C for M times; at the end of scaling, saving a code value obtained by ADC (analog-digital conversion) corresponding to each of the standard resistors into an internal memory of the central processing unit to obtain a correspondence between the code value obtained by ADC and the standard resistor;

S4: back-testing of the scaling: accessing a 1-10K resistor to the original blood equivalent impedance unit Rx the blood is not accessed to the circuit, measuring whether it is 1-10K, judging whether the measurement deviation exceeds a preset deviation value, if so, determining that the scaling does not pass and returning to S2; and if not, proceeding to S5;

where, in S4, the 1-10K resistor is preferably a 5K resistor and the preset deviation value is preferably 0.2%;

S5: circuit self-detection: turning the analog switch on, accessing the fifth resistor to the measurement circuit to measure the resistance of the fifth resistor, judging whether the error of the fifth resistor exceeds a preset value, if so, giving a prompt indicative of circuit abnormality and automatically terminating the measurement, and if not, performing the detection task by the detection system;

where, in S5, the preset value is preferably 0.2%.

An embodiment of the operation control method of the present invention will be described below.

In S1, the central processing unit is a single-chip computer, the monolithic function generator is a direct digital frequency synthesizer, and the single-chip computer outputs an instruction to the direct digital frequency synthesizer to control the direct digital frequency synthesizer to generate a standard sine wave.

In S2, the analog switch is turned off, the blood is not accessed, and a standard resistor for scaling is placed to the blood equivalent impedance unit.

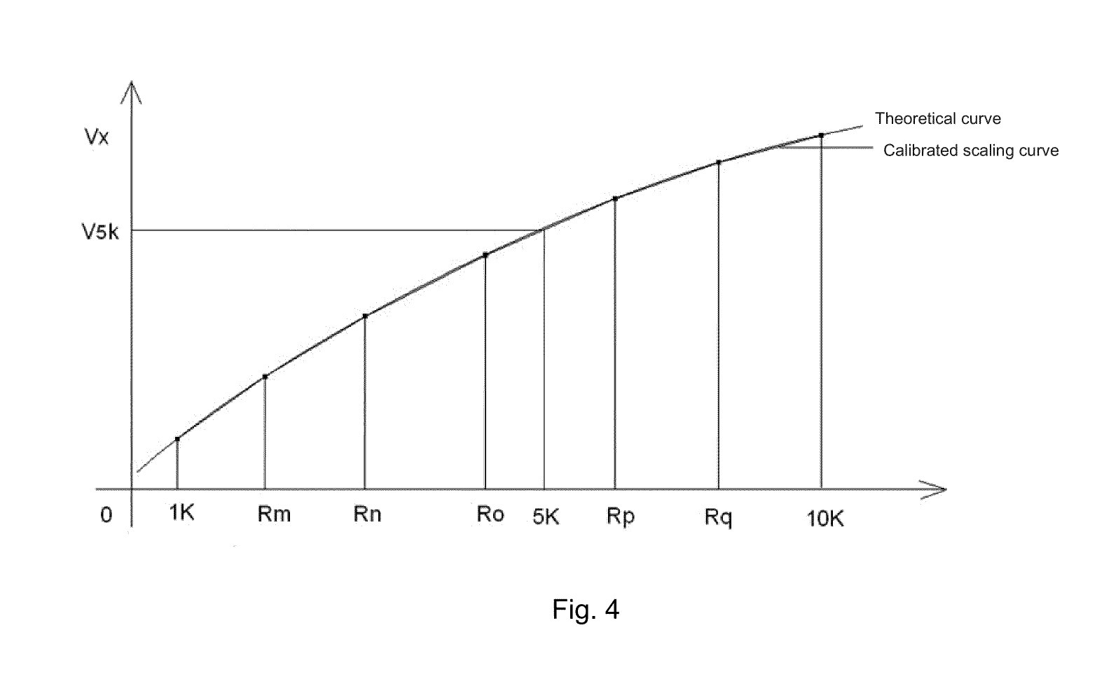

In S3, five scaling points are set within a typical impedance measurement range from 1K to 15K, S2 and S3 are repeatedly executed for five times, one scaling is started each time when one standard resistor is placed to the blood equivalent impedance unit in S2; at the end of scaling, a code value obtained by ADC (LSBm, LSBn, LSBo, LSBp, LSBq) corresponding to each of the standard resistors (Rm, Rn, Ro, Rp, Rq) into an internal memory of the single-chip computer to obtain a correspondence between the code value obtained by ADC (LSBm, LSBn, LSBo, LSBp, LSBq) and the standard resistor (Rm, Rn, Ro, Rp, Rq). As shown in FIG. 4, five straight lines may be obtained according to the correspondences described above, and the intersection points of adjacent straight lines are the five scaling points.

In S4, the way of modifying the scaling parameter may be increasing or decreasing the sine amplitude output by the DDS.

In S5, the analog switch is turned on, and the fifth resistor is thus accessed to the measurement circuit. Now, due to the self-detection, the blood is not accessed to the loop, there is thus no blood equivalent impedance unit and the resistance of the fifth resistor is not one of the resistances at the five scaling points. Therefore, whether the circuit works normally and whether the measurement precision of the circuit reaches the requirement both may be detected. If the error of the fifth resistor does not exceed 0.2%, the RMS value of the sine signal on the blood is measured. The RMS value of the sine signal on the blood is obtained through the codes obtained by ADC. By the scaling curve, the blood impedance value is calculated and the blood HCT value is then calculated.

The principle of measurement and scaling will be discussed below.

Assumed that the blood impedance to be tested is Rx, the amplitude of the excitation source is Vp, the partial voltage on the blood equivalent impedance is Vx, the input signal of RMS is Vsine, the output signal is Vdc, the code value obtained by ADC is LSB, and the ADC voltage reference VREF=5V, then:

$$\begin{matrix}\frac{Vx}{Vp} = \frac{Rx}{Rx + R 2} & ( 1 ) \\ Vdc = \frac{\sqrt{2}}{2} V sin e = \frac{\sqrt{2}}{2} * 10 * Vx & ( 2 ) \\ 2 * Vdc = \frac{5 V}{{2}^{24} - 1} * LSB & ( 3 )\end{matrix}$$

Vdc may be obtained from Formula (3) and then substituted into Formula (2) to obtain Vx, and Vx is then substituted into Formula (1). As Vp is a known, Rx may be obtained from Formula (1).

However, as Formula (1) is a quadratic function, the operation is complex. Therefore, in the present invention, multi-point scaling is used. For example, five points (Rm, Rn, Ro, Rp, Rq) are inserted from 1K to 15K to divide this range into six sections, with the value of each interval being far less than the serially-connected resistor R2, as shown in FIG. 4. Accordingly, each section may be regarded to be linear. Five straight lines may be produced by the multi-point scaling. The straight line, on which a code value collected by ADC is, may be determined. In this way, the accurate Rx value may be obtained quickly. As shown in FIG. 4, after the multi-point scaling, the corrected scaling curve is substantially coincided with the theoretical curve, thereby realizing high precision.

In the present invention, by multi-point scaling and performing piecewise linear treatment, a single correspondence is established between the resistor Rx to be tested and the code value obtained by ADC. In this way, the constant errors in the intermediate links, for example, the initial precision of the references REF1 and REF2, the imbalance between the ADC and the operational amplification, and the gain error of the ADC, may be eliminated. The dependence of the system on those parameters is reduced greatly. A high precision may be maintained for a circuit as long as there is no drift.

The CPU inputs a command, according to the program settings, to the monolithic function generator U3. Under the precise voltage reference, U3 outputs a sine wave with an amplitude of 1 Vpp. This sine wave has a crest of 1V and a trough of 0V. This signal is passed to C1 to be converted into a sine wave of ±500 mVpp, then buffered by U1, and finally directly applied to the serially-connected resistor R2 and the blood equivalent impedance RX. In a preferred embodiment, R2 has a resistance of 98 Kohm, and the blood equivalent impedance is usually from 2 Kohm to 10 Kohm.

Therefore,

at a minimum blood capacitive impedance,

the sine wave component on RX: ±500 mVpp*2K(98K+2K)=±10 mVpp;

at a maximum blood capacitive impedance,

the sine wave component on RX: ±500 mVpp*10K(98K+10K)=±46.3 mVpp

Signal of RX is passed to U2 to be amplified by twenty times, i.e., ±200 mVpp to ±926 mVpp.

Therefore, when the blood impedance changes within a maximum range from 2 Kohm to 10 Kohm, the input signal of the RMS chip is 02V to 0.926V, exactly within a range having a very good linearity, so that this input signal may be highly precisely converted into a DC signal by the RMS chip. The precision level may reach 0.15%. As the signal output by the RMS has been up to hundreds of millivolts, the precision of ADC collection may reach 0.02%. Accordingly, the whole measurement circuit may realize a precision of 0.2%, which is far greater than that of the traditional solutions. Meanwhile, the use of the self-detection circuit greatly improves the reliability of the measurement circuit device.

In the present invention, by using a stable DDS as the signal source and RMS as the detection chip, reliable working and excellent performance are realized, and the precision of blood impedance detection is substantively improved (may reach 0.2%). The deficiencies, i.e., low precision, large error and complex circuit, of the traditional HCT detection circuits are thoroughly solved.

The foregoing is just further detailed description of the present invention with specific preferred implementations. It should not be considered that the specific implementation of the present invention is limited thereto. For a person of ordinary skill in the art, various simple deductions and replacements may be made without departing from the concept of the present invention, and those deductions and replacements should be regarded as falling into the protection scope of the present invention.

What is claimed is:

1. A detection system for improving accuracy of hematocrit measurement, comprising a central processing unit (10), an excitation source unit (70), a blood sample unit (40), a precise measurement circuit unit (50) and a signal collecting unit (60); the central processing unit (10) is connected to the excitation source unit (70) and configured to output a control command to the excitation source unit (70); the excitation source unit (70) is configured to generate a sine wave, and the output end of the excitation source unit (70) is connected to the input end of the blood sample unit (40); the output end of the blood sample unit (40) is communicated to the input end of the precise measurement circuit unit (50), and the blood sample unit (40) is configured to collect a blood sample impedance signal; the precise measurement circuit unit (50) is configured to complete amplification of the signal and conversion of the signal to an effective value after the amplification; the signal collecting unit (60) is configured to complete single-ended to differential amplification and analog-digital conversion of a signal of the effective value of the blood impedance; the output end of the precise measurement circuit unit (50) is connected to the signal collecting unit (60), the central processing unit (10) is connected to the signal collecting unit (60), and the signal collecting unit (60) outputs the processed data of the effective value of the blood impedance to the central processing unit (10); and the central processing unit (10) calculates a blood impedance according to the effective value of the blood impedance, and the central processing unit (10) outputs a control command to the signal collecting unit (60).

2. The detection system according to claim 1, wherein the excitation source unit (70) comprises a waveform generator circuit (20) and a waveform converter circuit (30) connected to the waveform generator circuit (20); the waveform generator circuit (20) is configured to generate a sine wave; and the waveform converter circuit (30) is configured to isolate the DC component of a signal output from the waveform generator circuit (20) and convert a positive sine signal into a positive and negative half-cycle sine wave.

3. The detection system according to claim 2, wherein the waveform generator circuit (20) comprises a monolithic function generator (U3), a crystal oscillator unit (X1) and a precise voltage reference unit, the precise voltage reference unit being connected to a voltage reference interface of the monolithic function generator (U3) and configured to provide a precise voltage reference for the monolithic function generator (U3), the monolithic function generator (U3) being connected to the crystal oscillator unit (X1), the crystal oscillator unit (X1) being configured to provide a high-precision clock signal; and the input end of the waveform converter circuit (30) is connected to the output end of the monolithic function generator (U3), and configured to isolate the DC component of a signal output from the monolithic function generator (U3) and convert a positive sine signal into a positive and negative half-cycle sine wave.

4. The detection system according to claim 3, wherein the waveform converter circuit (30) comprises a capacitor (C1), a first resistor (R1) and a first operational amplifier unit (U1); one end of the capacitor (C1) is connected to the output end of the monolithic function generator (U3), and the other end of the capacitor (C1) is connected to the resistor (R1) and the in-phase input end of the first operational amplifier unit (U1); the other end of the first resistor (R1) is grounded; the in-phase end of the first operational amplifier unit (U1) is connected to a common node of the capacitor (C1) and the first resistor (R1); and one end of a second resistor (R2) is connected to the output end of the first operational amplifier unit (U1).

5. The detection system according to claim 4, wherein the blood sample unit (40) is a circuit to be tested; the blood sample unit (40) comprises a second resistor (R2), a fifth resistor (R5), an analog switch (K1) and a blood equivalent impedance unit (RX); one end of the second resistor (R2) is connected to the output end of the excitation source unit (70); one end of the blood equivalent impedance unit (RX) is connected to the second resistor (R2), and the other end of the blood equivalent impedance unit (RX) is grounded; one end of the fifth resistor (R5) is connected to the second resistor (R2), and the other end of the fifth resistor (R5) is connected to one end of the analog switch (K1); the other end of the analog switch (K1) is grounded; and both the second resistor (R2) and the fifth resistor (R5) are standard resistors.

6. The detection system according to claim 5, wherein the precise measurement circuit unit (50) comprises a second operational amplifier unit (U2), a third resistor (R3), a fourth resistor (R4) and a root mean square converter chip (U4); the in-phase end of the second operational amplifier unit (U2) is connected to a common node of the second resistor (R2) and the blood equivalent impedance unit (RX), and the out-phase end of the second operational amplifier unit (U2) is connected to a common node of the third resistor (R3) and the fourth resistor (R4); the output of the second operational amplifier unit (U2) is connected to the third resistor (R3) and the input end of the root mean square converter chip (U4), and the input end of the root mean square converter chip (U4) is connected to a common node of the output end of the second operational amplifier unit (U2) and the third resistor (R3); and the other end of the fourth resistor (R4) is grounded.

7. The detection system according to claim 6, wherein the signal collecting unit (60) comprises a high-resolution analog-digital converter (U6), an analog-digital converter driving circuit (U5) and a precise voltage reference unit; the input end of the analog-digital converter driving circuit (U5) is connected to the output end of the root mean square converter chip (U4), and the output end of the analog-digital converter driving circuit (U5) is connected to the input end of the high-resolution analog-digital converter (U6); the high-resolution analog-digital converter (U6) is connected to the output end of the precise voltage reference unit; and the high-resolution analog-digital converter (U6) is connected to the central processing unit (10).

8. The detection system according to claim 7, wherein the monolithic function generator (U3) is a direct digital frequency synthesizer which is produced by the AD Company (model: AD9832); and the high-resolution analog-digital converter (U6) is a Delta-Sigma analog-digital converter.

9. The detection system according to claim 8, wherein there are two precise voltage reference units, respectively a first precise voltage reference unit (REF1) and a second precise voltage reference unit (REF2); the first precise voltage reference unit (REF1) is connected to the voltage reference interface of the monolithic function generator (U3) and configured to provide a precise voltage reference for the monolithic function generator (U3); and the high-resolution analog-digital converter (U6) is connected to the output end of the second precise voltage reference unit (REF2).

10. An operation control method for a detection system, comprising the following steps:
A) generating a standard sine wave: outputting, by a central processing unit, an instruction to a monolithic function generator to control the monolithic function generator to generate a standard sine wave;
B) setting a standard value: turning an analog switch off, not accessing a blood equivalent impedance unit to the blood, and placing a standard resistor for scaling into the blood equivalent impedance unit;
C) scaling a circuit: setting M scaling points within a typical impedance measurement range from 1K to 15K, where M is greater than or equal to 2, starting the circuit once for scaling each time when one standard resistor is placed to the blood equivalent impedance unit in step B, and repeatedly executing step B and step C for M times; at the end of scaling, saving a code value obtained by ADC (analog-digital conversion) corresponding to each of the standard resistors into an internal memory of the central processing unit to obtain a correspondence between the code value obtained by ADC and the standard resistor;
D) back-testing of the scaling: accessing a resistor having a resistance of R to the original blood equivalent impedance unit Rx, judging whether the measurement deviation exceeds a preset deviation value, if so, returning to step B; and if not, executing step E, where R is from 1KΩ to 10KΩ; and
E) circuit self-detection: turning the analog switch on, accessing the fifth resistor to the measurement circuit to measure the resistance of the fifth resistor, judging whether the error of the fifth resistor exceeds a preset value, if so, giving a prompt indicative of circuit abnormality and automatically terminating the measurement, and if not, performing the detection task by the detection system.
